(19) United States
(12) Patent Application Publication
(10) Pub. No.: US 2008/0002894 A1
(43) Pub. Date: Jan. 3, 2008

(54) Signature-based video redirection

(75) Inventors: Yoel Hayon, Givatayim (IL); Uri Trichter, Herzlia (IL); Boaz Tabachnik, Gimzo (IL)

Correspondence Address: DARBY & DARBY P.C., P.O. BOX 770, Church Street Station, New York, NY, 10008-0770, US

(73) Assignee: WINBOND ELECTRONICS CORPORATION, Hsinchu (TW)

(21) Appl. No.: 11/479,090

(22) Filed: Jun. 29, 2006

(51) Int. Cl. G06K 9/00; G06K 9/36; G06K 9/46

(52) U.S. Cl. 382/232; 382/103

(57) ABSTRACT

A method for detecting changes in a sequence of images includes dividing each of the images into tiles, each tile including a group of pixels. A tile signature representing the pixel values of the pixels of a given tile using a single numerical value is defined, such that a change in the signature is indicative of a change in at least one of the pixel values of the pixels of the given tile. Reference signatures of the tiles of a first image in the sequence are computed and stored. Current signatures of the tiles of a second image in the sequence are computed. An indication of changed tiles in the second image with respect to the first image is outputted by comparing the respective current signatures to the respective reference signatures of the tiles.

### FIELD OF THE INVENTION

The present invention relates generally to remote control of computing platforms, and particularly to methods and systems for capturing and redirection of video frames.

### BACKGROUND OF THE INVENTION

Capturing of images, and in particular video images, is performed in a variety of applications. For example, some remote control applications transfer video frames from a remotely-controlled computer to a controlling computer. Remote control methods and systems are described, for example, in U.S. Patent Application Publication 2004/0083256 A1, U.S. Pat. No. 6,304,895, U.S. Patent Application Publication 2005/0114894 A1, and U.S. Patent Application Publication 2005/0105608 A1, whose disclosures are incorporated herein by reference.

Some remote control applications also transfer mouse and keyboard signaling from the controlling computer to the controlled computer. Such remote control applications are often referred to as keyboard-video-mouse (KVM) applications. Several vendors offer hardware and/or software KVM solutions, such as KVM-over-IP solutions. Such vendors include, for example, Peppercom USA, Inc. (Tucker, Ga.) and Avocent Corp. (Huntsville, Ala.). Further details regarding these products can be found at www.peppercom.com and www.avocent.com, respectively.

### SUMMARY OF THE INVENTION

Embodiments of the present invention provide improved methods and systems for detecting changes in digitally-represented images. These methods and systems can be used, for example, for efficiently transferring video frames from a remote computer to a controlling computer.

In embodiments of the present invention, image frames are divided into multiple blocks, referred to herein as “tiles.” The pixel values associated with a particular tile are represented by a compact signature, such as a cyclic redundancy check (CRC) or a hash value. In order to detect changes between a currently-captured frame and a previously-captured reference frame, tile signatures of the current frame are compared with the corresponding reference signatures of the reference frame. When the current and reference signatures of a particular tile differ, the tile is marked as a changed tile.

When the methods and systems described herein are used for transferring video images from a remote computer to a controlling computer, the reference frame is typically stored in the controlling computer. The current frame is captured at the remote computer, and changed tiles are identified using signature comparison. At least some of the changed tiles are transmitted to the controlling computer over a communication link. The controlling computer reconstructs and updates the reference frame using the tiles transmitted to it.

Unlike some known image capturing methods in which the currently-captured image and/or reference image are stored in one or more frame buffers at the remote computer, the disclosed methods and systems enable the remote computer to store only the reference tile signatures, plus a small number of cached changed tiles. Thus, the memory required at the remote computer is significantly reduced, and may often utilize inexpensive on-chip processor memory. Furthermore, the memory access bandwidth is significantly lower in comparison to known methods.

There is therefore provided, in accordance with an embodiment of the present invention, a method for detecting changes in a sequence of images that include pixels having respective pixel values, the method including:

dividing each of the images into tiles, each tile including a group of the pixels;

defining a tile signature that represents the pixel values of the pixels of a given tile using a single numerical value, such that a change in the signature is indicative of a change in at least one of the pixel values of the pixels of the given tile;

computing and storing respective reference signatures of the tiles of a first image in the sequence based on the pixel values of the pixels in each of the tiles in the first image;

computing respective current signatures of the tiles of a second image in the sequence based on the pixel values of the pixels in each of the tiles in the second image; and

outputting an indication of changed tiles in the second image with respect to the first image by comparing the respective current signatures to the respective reference signatures of the tiles.

In an embodiment, defining the tile signature includes defining at least one of a cyclic redundancy check (CRC) and a hashing function.

In another embodiment, outputting the indication includes identifying the changed tiles when the respective current signatures differ from the respective reference signatures, and setting respective Boolean flags indicating the identified changed tiles in a tile difference table. Additionally or alternatively, outputting the indication includes capturing and outputting the pixel values of at least some of the changed tiles in a third image subsequent to the second image in the sequence. Further additionally or alternatively, outputting the indication includes storing only changed tiles of the second image.

In yet another embodiment, each of the images is divided into N tiles, and the method includes storing no more than 0.02N of the tiles of the second image. In still another embodiment, storing no more than 0.02N of the tiles includes storing no more than 0.01N of the tiles of the second image.

In an embodiment, outputting the indication includes defining a prioritization over the changed tiles and selecting and outputting one or more of the changed tiles responsively to the prioritization. In another embodiment, the second image is acquired in accordance with a scanning pattern, and defining the prioritization includes selecting the one or more of the changed tiles responsively to a current position in the scanning pattern. In another embodiment, outputting the indication includes producing an interrupt responsively to identifying a changed tile, and defining the prioritization includes outputting the identified changed tile responsively to the interrupt.

In another embodiment, the sequence of images is produced at a remote computer, and outputting the indication includes transmitting at least some of the changed tiles over a communication link to a controlling computer. In yet another embodiment, the method includes reconstructing the second image at the controlling computer using the first image and the transmitted changed tiles, and displaying the reconstructed second image to a user.

In still another embodiment, dividing the images into the tiles includes defining first and second partially overlapping tiles such that at least one of the pixels is common to the first and second tiles.

There is additionally provided, in accordance with an embodiment of the present invention, a method for transferring a sequence of video frames that include pixels having respective pixel values from a remote computer to a controlling computer, the method including:

dividing each of the video frames into tiles, each tile including a group of the pixels;

defining a tile signature that represents the pixel values of the pixels of a given tile using a single numerical value, such that a change in the signature is indicative of a change in at least one of the pixel values of the pixels of the given tile;

at the remote computer, computing and storing respective reference signatures of the tiles of a first video frame in the sequence based on the pixel values of the pixels in each of the tiles in the first video frame;

computing respective current signatures of the tiles of a second video frame in the sequence based on the pixel values of the pixels in each of the tiles in the second video frame;

identifying changed tiles in the second video frame with respect to the first video frame by comparing the respective current signatures to the respective reference signatures of the tiles; and

transmitting at least some of the changed tiles over a communication link from the remote computer to the controlling computer.

In an embodiment, the method includes reconstructing the sequence of video frames at the controlling computer using the transmitted changed tiles, and displaying the reconstructed video frames to a user. Additionally or alternatively, the method may include controlling the remote computer from the controlling computer using the reconstructed video frames.

In another embodiment, transmitting the at least some of the changed tiles includes refraining from transmitting unchanged tiles to the controlling computer. In yet another embodiment, identifying the changed tiles includes refraining from storing unchanged tiles in the remote computer.

There is also provided, in accordance with an embodiment of the present invention, apparatus for detecting changes in a sequence of images that include pixels having respective pixel values, including:

a capture processor, which is arranged to accept the sequence of images, to divide each of the images into tiles, each tile including a group of the pixels, to accept a definition of a tile signature representing the pixel values of the pixels of a given tile using a single numerical value, such that a change in the signature is indicative of a change in at least one of the pixel values of the pixels of the given tile, to compute and store respective reference signatures of the tiles of a first image in the sequence based on the pixel values of the pixels in each of the tiles in the first image, to compute respective current signatures of the tiles of a second image in the sequence based on the pixel values of the pixels in each of the tiles in the second image, and to identify changed tiles in the second image with respect to the first image by comparing the respective current signatures to the respective reference signatures of the tiles; and

a controller, which is arranged to output an indication of the changed tiles.

There is further provided, in accordance with an embodiment of the present invention, a system for transferring a sequence of video frames that include pixels having respective pixel values, including:

a remote computer, including:

a graphic processor, which is arranged to produce the sequence of video frames; and

a capture processor, which is arranged to divide each of the video frames into tiles, each tile including a group of the pixels, to accept a definition of a tile signature that represents the pixel values of the pixels of a given tile using a single numerical value, such that a change in the signature is indicative of a change in at least one of the pixel values of the pixels of the given tile, to compute and store respective reference signatures of the tiles of a first video frame in the sequence based on the pixel values of the pixels in each of the tiles in the first video frame, to accept an input data sequence representing respective current pixel values of a second video frame, to compute respective current signatures of the tiles of a second video frame in the sequence based on the pixel values of the pixels in each of the tiles in the second video frame, to identify changed tiles in the second video frame with respect to the first video frame by comparing the respective current signatures to the respective reference signatures of the tiles, and to transmit at least some of the changed tiles over a communication link; and

a controlling computer, which is arranged to accept the changed tiles transmitted over the communication link and to reconstruct the sequence of video frames using the changed tiles.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for video redirection, in accordance with an embodiment of the present invention;

FIG. 2 is a diagram that schematically illustrates the operation of a capture processor, in accordance with an embodiment of the present invention; and

FIG. 3 is a flow chart that schematically illustrates a method for signature-based video redirection, in accordance with an embodiment of the present invention.

### DETAILED DESCRIPTION OF EMBODIMENTS

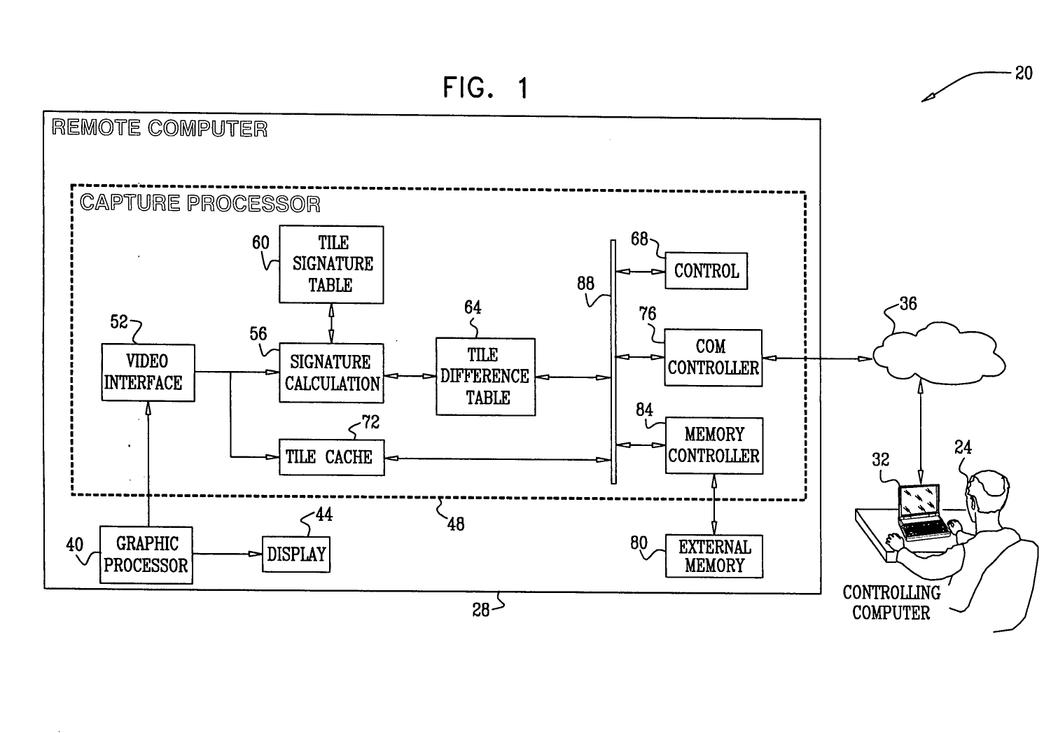

FIG. 1 is a block diagram that schematically illustrates a system 20 for video redirection, in accordance with an embodiment of the present invention. A user 24, such as a system administrator or other operator, uses system 20 to view the video images generated by a remote computer 28 on a video display of a controlling computer 32. The remote computer is connected to the controlling computer via a communication link 36, in the present example comprising a wide-area network (WAN), such as the Internet.

The video redirection functionality of system 20 may be part of a remote control system, such as a keyboard-video-mouse (KVM) system, in which the user remotely controls remote computer 28. In such systems, keyboard and/or mouse signaling is transmitted over communication link 36 from the controlling computer to the remote computer. Alternatively, system 20 may be used as a monitoring application that transfers video only. In some embodiments, the video transferred to the controlling computer is formatted in accordance with a known protocol, such as the remote frame buffer (RFB) protocol, a widely-used protocol for interaction with remote computers. Virtual Network Computing (VNC) is an exemplary remote control software package, offered by RealVNC Ltd. (Cambridge, England), that uses the RFB protocol. Details regarding RFB and VNC are available at www.realvnc.com.

The exemplary embodiment of FIG. 1, as well as other embodiments described herein, refer to a single remote computer 28 controlled by a single controlling computer 32 for simplicity of explanation. System 20 may comprise, however, multiple remote computers 28 whose video is redirected to controlling computer 32. For example, the system may comprise a plurality of servers in a clustered configuration, which are remotely monitored and/or controlled by a system administrator using controlling computer 32. Additionally or alternatively, system 20 may comprise more than one controlling computer.

The term “remote computer” means that computer 28 and computer 32 are separate computing platforms, and does not imply any distance relationship between them. Controlling computer 32 may be located either in proximity to or remotely from remote computer 28. Remote computer 28 may comprise a personal computer, a laptop, a workstation, a server, a blade in a multi-processor frame, or any other suitable computing platform that produces video frames.

Communication link 36 may comprise any suitable link that connects remote computer 28 with controlling computer 32, such as an internet protocol (IP) network, a local-area network (LAN), a WAN, a packet network, a point-to-point or point-to-multipoint connection, a wired or wireless connection, a dial-up or a fixed connection, or a combination of these connection types.

Remote computer 28 comprises a graphic processor 40, which generates digitally-represented video image frames. The video images are compressed and redirected to controlling computer 32, using methods that will be described in detail hereinbelow. In some embodiments, the video images are displayed on a local display 44 in Addition to being redirected to controlling computer 32.

Remote computer 28 comprises a capture processor 48, which captures, compresses and transmits the video frames over communication link 36 to controlling computer 32. The capture processor may be implemented as an integrated circuit (IC), such as an application-specific IC (ASIC), which is part of remote computer 28. The capture processor may alternatively be fabricated using discrete components or as a combination of discrete components and ICs in remote computer 28. At least some circuitry and/or functions of the capture processor may be integrated with or share common resources with other hardware components of the remote computer. The capture processor may reside either on the motherboard or on an extension board of the remote computer. In some embodiments, processor 48 is integrated, along with other functions, into a baseboard management controller (BMC) chip. Alternatively or additionally, at least some of the functions of the capture processor may be carried out in software on a general-purpose microprocessor or digital signal processor.

In order to reduce the communication bandwidth used for transferring the video frames over communication link 36, capture processor 48 compresses the video frames before transmitting them to controlling computer 32. The compression is based on detecting variations between pixel values of a previously-captured reference frame (referred to as reference pixel values) with corresponding pixel values of the currently-captured frame (referred to as current pixel values). The reference frame is typically stored in the controlling computer.

The compression process carried out by capture processor 48 takes into account the fact that consecutive video frames are often similar to one another, and that variations between consecutive frames are often limited to certain locations in the frame. In order to take advantage of these assumptions, each of the reference and current video frames is divided into a plurality of blocks or regions, referred to herein as tiles. As will be described below, only tiles that have changed in comparison to their counterparts in the reference frame are transmitted to the controlling computer. These tiles are referred to as changed tiles. The controlling computer uses the changed tiles to update its reference frame and display it to user 24.

In some embodiments, the tiles are square in shape and may have any suitable size, such as 16 by 16 or 32 by 32 pixels. In general, however, the tiles may be rectangular (i.e., having different height and width) or have any other suitable shape. The tiles need not all have the same size or shape. Neighboring tiles may partially overlap with one another, i.e., some pixels may be associated with more than a single tile.

Unlike some known image capturing, compression and/or redirection methods in which the remote computer stores the captured image (or significant parts thereof) in a frame buffer, the methods and systems described herein eliminate the need for such a frame buffer. Only changed tiles that should be sent to the controlling computer are temporarily cached.

Thus, the memory size used by capture processor 48 is typically on the order of only several tens of tiles and often less, which make up only a fraction of the number of tiles of the entire frame, typically less than 2% of the total number of tiles in the frame and often less than 1%. When capture processor 48 is implemented in an integrated circuit (IC), the reduced memory requirements often enable the use of inexpensive on-chip memory. Furthermore, the memory access bandwidth (i.e., the bit rate at which data is written into and read out of memory) is also significantly reduced. As a result, tiles can be cached in an off-chip memory that is external to capture processor 48.

In order to reduce the memory size and memory bandwidth requirements, the pixel values of each captured tile are compactly represented by a single numerical value called a signature. For example, the pixel values of a tile can be collectively represented by a 16- or 32-bit cyclic redundancy check (CRC) value, as is known in the art. Consider an exemplary embodiment in which the frame is divided into tiles of 16 by 16 pixels, with each pixel encoded using 16 bits. Each raw tile is thus represented by a total of 16·16·16=4096 bits, or 512 bytes. Representing each tile using a 32-bit CRC reduces the memory space requirement by a factor of 4096/32=128. In the present example, a 1024 by 768 pixel video frame, divided into 3072 tiles, would require 1.5 Mbytes of memory space. Using 32-bit CRC, the tile signatures of this frame can be stored using only 12 Kbytes. Assuming up to 32 changed tiles are cached in their raw format, 16 Kbytes are added, to provide a total of approximately 28 Kbytes, which can typically be provided on-chip.

Alternatively to using CRC, a suitable hashing function can be used to generate tile signatures, mapping the multiple pixel values of a certain tile to a single hash value. Further alternatively, any other suitable signature can be used.

In the context of the present patent application and in the claims, the term “signature” is used to describe any compact representation of a tile using a single numerical value, such that a change in one or more pixel values of the tile would cause, with sufficiently high probability (typically in excess of 99.99%), a corresponding change in the signature. In other words, a difference between two tile signatures is considered indicative, with high probability, of a difference in at least one pixel of the respective tiles.

The signature should be chosen so that changed tiles are rarely missed. If a change in a tile is missed, and the changed tile is not transmitted to the controlling computer, the reference frame at the controlling computer will be distorted until the change is detected. Thus, the misdetection probability of the signature (i.e., the probability that a difference in pixel values will not change the signature value) should be sufficiently low so as not to produce a noticeable degradation of the image quality at the controlling computer. There is usually a trade-off between the size of the signature (i.e., the range of numerical values to which tiles are mapped) and its misdetection probability.

The digital video generated by graphic processor 40 is provided to a video interface 52 in capture processor 48. Thus, interface 52 accepts an input data sequence, which comprises a sequence of pixel values representing the current video frame. The specific format of the input data sequence depends on several factors, such as the screen resolution used by the remote computer, the color resolution used, the number of bits selected to represent each pixel value and the frame refresh rate.

Typically, the capture processor accepts video frames having a resolution of between 640 by 480 and 1280 by 1024 pixels per frame, although other ranges can also be used. Each pixel value is typically represented using 16 bits, although other pixel resolutions are also feasible. The frame refresh rate handled by the capture processor is typically between 25 and 160 Hz, although any other suitable refresh rate can be used. In some embodiments, the video provided to capture processor 48 adheres to a known digital graphics standard, such as a video graphics array (VGA), super VGA (SVGA), extended graphic array (XGA), as well as other video electronics standards association (VESA) display standards.

Capture processor 48 comprises a signature calculation module 56, which accepts tiles of the currently-captured video frame and calculates the signature of each tile. Module 56 typically comprises hardware circuitry that operates at the rate of the input sequence, i.e., calculates the tile signatures “on the fly” as the tiles are being captured. The specific internal structure of module 56, e.g., a CRC encoder or hash generator, depends on the choice of signature.

Capture processor 48 comprises a tile signature table 60, which holds the signatures of the tiles that were previously transmitted to controlling computer 32, i.e., the tiles of the reference frame. In other words, table 60 holds the tile signature values, as they are known to controlling computer 32. As digital video is provided by interface 52, signature calculation module 56 calculates the current tile signatures and compares them to the corresponding reference signatures stored in tile signature table 60.

Capture processor 48 further comprises a tile difference table 64, which holds Boolean flags indicating whether the current signatures (i.e., the tile signatures of currently-captured tiles) differ from the corresponding reference signatures. Table 64 comprises a flag for each tile, and may be implemented as a bit array stored in a memory of processor 48, or using any other suitable implementation. The tile difference table is continuously updated by signature calculation module 56. When module 56 detects a difference between the reference and current signatures of a particular tile, it marks the tile as a changed tile and sets the appropriate element (flag) in table 64. When a certain changed tile is transmitted to the controlling computer, module 56 updates signature table 60 with the current tile signature (assuming that the reference frame is updated with this changed tile). Module 56 also resets the appropriate element in tile difference table 64, to indicate that the current and reference signatures of this tile are no longer different.

In some embodiments, the process of analyzing current tiles, calculating their signatures and updating tile difference table 64 is performed repeatedly on the input video frames, regardless of whether or not changed tiles are transmitted to the controlling computer.

Capture processor 48 comprises a control module 68, which selects tiles intended for transmission to the controlling computer. Control module 68 has access to the flags of tile difference table 64, and it thus aware of which tiles are marked as changed tiles. The control module selects tiles for transmission out of the changed tiles, and controls the capturing of the selected tiles into a tile cache 72. In some embodiments, tile cache 72 comprises logic circuitry (e.g., a state machine) that accepts requests from control module 68 and captures the requested tiles. Alternatively, the capturing can be performed by control module 68, which then writes the tiles into cache 72.

A communication controller 76 transmits the tiles written into cache 72 to controlling computer 32 via communication link 36. The dimensioning of cache 72 may depend, for example, on the available bandwidth of link 36 and on the rate in which changed tiles are added. As noted above, tile cache 72 has a typical size of several tens of tiles.

Control module 68 may use any suitable logic or criteria for selecting which changed tiles to transmit to the controlling computer. For example, in many practical scenarios, a region of the displayed video is scrolled, such as when new text is being typed and displayed in the remote computer. In such cases, it is sometimes desirable to give higher priority to changed tiles located at the bottom of the scrolled area, where new text is being typed.

As another example, it is sometimes desirable to transmit groups of adjacent changed tiles located in consecutive regions of the frame, rather than transmitting changed tiles that are scattered at different locations. Updating consecutive regions of the frame often appears as a smoother video display at the controlling computer. The consecutive regions may comprise, for example, vertical or horizontal strips in the frame. Vertical strips are sometimes preferred because they allow more time for processing and transmitting the changed tiles.

Additionally or alternatively, a particular region of the frame may be defined as a priority region. Tiles belonging to this region can be given a higher priority over other changed tiles. As another example, signature calculation module 56 may provide an interrupt to module 68 whenever it detects a changed tile (i.e., whenever it sets a flag in tile difference table 64). Module 68 is triggered by the interrupt and instructs that the changed tile be transmitted. Alternatively, control module 68 may periodically poll table 64 to check for newly-changed tiles. Module 68 may be implemented using hardware, firmware, software, or combinations thereof.

In some embodiments, module 68 takes into account the scanning pattern using which the current frame is acquired. In other words, the control module is aware of which pixels of the current image are being captured by video interface 52 at any given moment. Module 68 can use this timing information to reduce the latency of transmitting changed tiles to the controlling computer. For example, module 68 may select a tile that is about to be captured, so as to minimize the update latency.

As noted above, changed tiles can be cached externally to capture processor 48. For example, processor 48 may comprise a memory controller 84, which exchanges data with an external memory 80. Memory 80 may comprise a shared memory, which is used by other elements of the remote computer in addition to processor 48. In the exemplary embodiment of FIG. 1, control module 68, communication controller 76, memory controller 84, tile cache 72 and tile difference table 64 are interconnected by an internal bus 88.

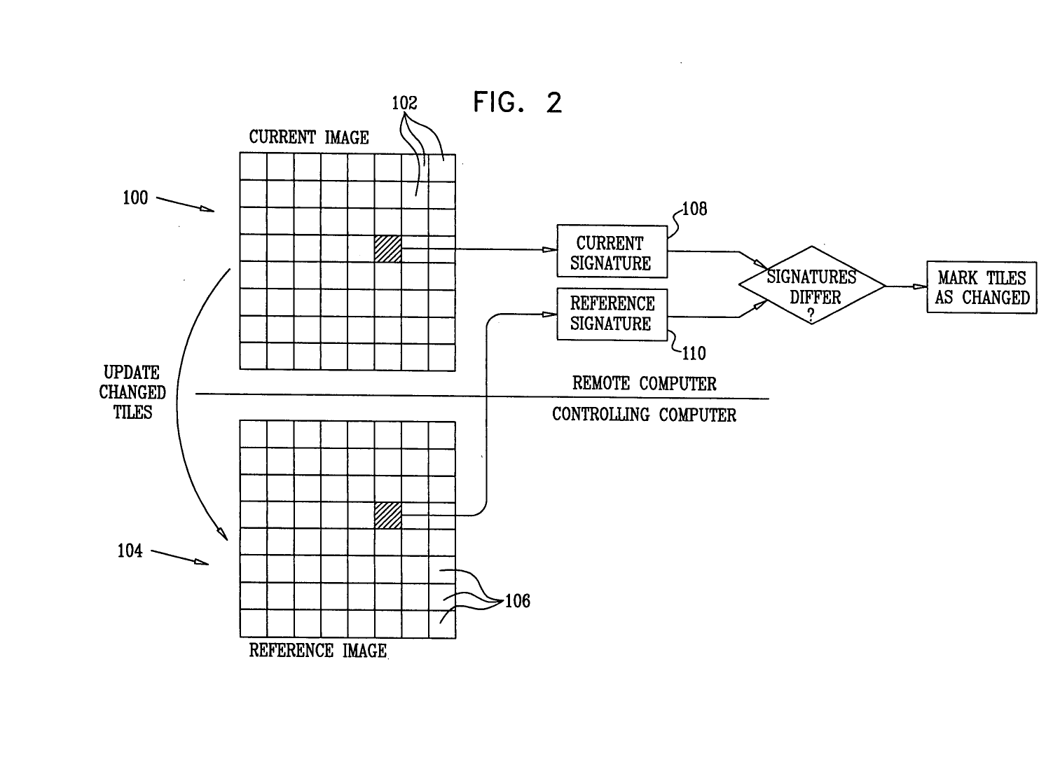

FIG. 2 is a diagram that schematically illustrates aspects of the operation of capture processor 48, in accordance with an embodiment of the present invention. The figure shows a currently-captured video frame 100 divided into current tiles 102 at the remote computer, and a reference video frame 104 divided into reference tiles 106 at the controlling computer. A current signature 108 of a certain current tile is calculated by module 56. A reference signature 110 of the corresponding reference tile is stored in tile signature table 60 in the remote computer. Module 56 compares the current signature to the reference signature and, if the signatures differ, marks the tile as a changed tile. As described above, the changed tiles are gradually updated, i.e., transmitted to the controlling computer.

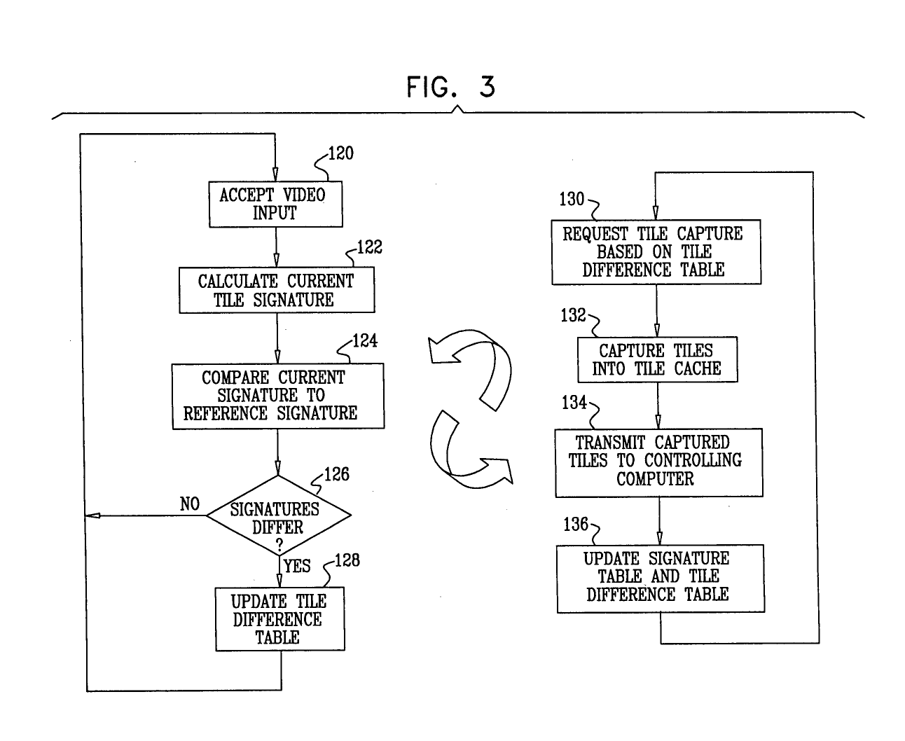

FIG. 3 is a flow chart that schematically illustrates a method for signature-based video redirection, in accordance with an embodiment of the present invention. The method comprises two repetitive processes, which, although related, are performed in parallel and separately from one another.

The first process begins with video interface 52 of capture processor 48 accepting input video image frames, at an input step 120. Signature calculation module 56 calculates the tile signatures of the currently-captured frame, at a current signature calculation step 122.

For each tile, module 56 compares the current signature to the corresponding reference signature stored in tile signature table 60, at a signature comparison step 124. If the signatures differ, as checked at a difference checking step 126, module 56 marks the tile as a changed tile. Module 56 sets the flag corresponding to the changed tile in tile difference table 64, at a flag setting step 128. The method loops back to input step 120 above to continue capturing the current image. If, on the other hand, the current and reference signatures do not differ at step 126, the method loops back to input step 120 above without updating the tile difference table.

The first process, comprising steps 120-128 above, keeps updating tile difference table 64 in real time. The second process, comprising steps 130-136 below, uses the tile difference table to select and transmit changed tiles to the controlling computer.

In general, the two processes may be performed at different times and in different frames. In other words, marking a tile as a changed tile means identifying a particular location or coordinate in which a change occurred. Capturing a tile at this location and transmitting it to the controlling computer may be performed either during the same frame in which the tile was marked, or later, in a subsequent frame.

The second process begins with control module 68 selecting one or more tiles out of the changed tiles to be transmitted to controlling computer 32, at a tile selection step 130. As noted above, any suitable selection criteria or logic can be used for this purpose. The selected tiles are captured and cached in tile cache 72, at a caching step 132.

Communication controller 76 transmits the tiles cached in tile cache 72 to controlling computer 32 via link 36, at a transmission step 134. The controlling computer receives the changed tiles transmitted to it and uses them to reconstruct the reference frame and display it to user 24. When a tile is captured and written into cache 72, signature calculation module 56 updates signature table 60 with the value of the current signature, at a signature updating step 136.

Although the methods and devices described herein mainly relate to the capturing, compression and redirection of video images, the principles of the present invention can be used in any image capturing application that involves detection of changes in an image with respect to a reference image.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for detecting changes in a sequence of images that include pixels having respective pixel values, the method comprising:
dividing each of the images into tiles, each tile comprising a group of the pixels;
defining a tile signature that represents the pixel values of the pixels of a given tile using a single numerical value, such that a change in the signature is indicative of a change in at least one of the pixel values of the pixels of the given tile;
computing and storing respective reference signatures of the tiles of a first image in the sequence based on the pixel values of the pixels in each of the tiles in the first image;
computing respective current signatures of the tiles of a second image in the sequence based on the pixel values of the pixels in each of the tiles in the second image; and
outputting an indication of changed tiles in the second image with respect to the first image by comparing the respective current signatures to the respective reference signatures of the tiles.

2. The method according to claim 1, wherein defining the tile signature comprises defining at least one of a cyclic redundancy check (CRC) and a hashing function.

3. The method according to claim 1, wherein outputting the indication comprises identifying the changed tiles when the respective current signatures differ from the respective reference signatures, and setting respective Boolean flags indicating the identified changed tiles in a tile difference table.

4. The method according to claim 1, wherein outputting the indication comprising capturing and outputting the pixel values of at least some of the changed tiles in a third image subsequent to the second image in the sequence.

5. The method according to claim 1, wherein outputting the indication comprises storing only changed tiles of the second image.

6. The method according to claim 1, wherein each of the images is divided into N tiles, and comprising storing no more than 0.02N of the tiles of the second image.

7. The method according to claim 6, wherein storing no more than 0.02N of the tiles comprises storing no more than 0.01N of the tiles of the second image.

8. The method according to claim 1, wherein outputting the indication comprises defining a prioritization over the changed tiles and selecting and outputting one or more of the changed tiles responsively to the prioritization.

9. The method according to claim 8, wherein the second image is acquired in accordance with a scanning pattern, and wherein defining the prioritization comprises selecting the one or more of the changed tiles responsively to a current position in the scanning pattern.

10. The method according to claim 8, wherein outputting the indication comprises producing an interrupt responsively to identifying a changed tile, and wherein defining the prioritization comprises outputting the identified changed tile responsively to the interrupt.

11. The method according to claim 1, wherein the sequence of images is produced at a remote computer, and wherein outputting the indication comprises transmitting at least some of the changed tiles over a communication link to a controlling computer.

12. The method according to claim 11, and comprising reconstructing the second image at the controlling computer using the first image and the transmitted changed tiles, and displaying the reconstructed second image to a user.

13. The method according to claim 1, wherein dividing the images into the tiles comprises defining first and second partially overlapping tiles such that at least one of the pixels is common to the first and second tiles.

14. A method for transferring a sequence of video frames that include pixels having respective pixel values from a remote computer to a controlling computer, the method comprising:
dividing each of the video frames into tiles, each tile comprising a group of the pixels;
defining a tile signature that represents the pixel values of the pixels of a given tile using a single numerical value, such that a change in the signature is indicative of a change in at least one of the pixel values of the pixels of the given tile;
at the remote computer, computing and storing respective reference signatures of the tiles of a first video frame in the sequence based on the pixel values of the pixels in each of the tiles in the first video frame;
computing respective current signatures of the tiles of a second video frame in the sequence based on the pixel values of the pixels in each of the tiles in the second video frame;
identifying changed tiles in the second video frame with respect to the first video frame by comparing the respective current signatures to the respective reference signatures of the tiles; and
transmitting at least some of the changed tiles over a communication link from the remote computer to the controlling computer.

15. The method according to claim 14, and comprising reconstructing the sequence of video frames at the controlling computer using the transmitted changed tiles, and displaying the reconstructed video frames to a user.

16. The method according to claim 15, and comprising controlling the remote computer from the controlling computer using the reconstructed video frames.

17. The method according to claim 14, wherein transmitting the at least some of the changed tiles comprises refraining from transmitting unchanged tiles to the controlling computer.

18. The method according to claim 14, wherein identifying the changed tiles comprises refraining from storing unchanged tiles in the remote computer.

19. Apparatus for detecting changes in a sequence of images that include pixels having respective pixel values, comprising:
a capture processor, which is arranged to accept the sequence of images, to divide each of the images into tiles, each tile comprising a group of the pixels, to accept a definition of a tile signature representing the pixel values of the pixels of a given tile using a single numerical value, such that a change in the signature is indicative of a change in at least one of the pixel values of the pixels of the given tile, to compute and store respective reference signatures of the tiles of a first image in the sequence based on the pixel values of the pixels in each of the tiles in the first image, to compute respective current signatures of the tiles of a second image in the sequence based on the pixel values of the pixels in each of the tiles in the second image, and to identify changed tiles in the second image with respect to the first image by comparing the respective current signatures to the respective reference signatures of the tiles; and
a controller, which is arranged to output an indication of the changed tiles.

20. The apparatus according to claim 19, wherein the tile signature comprises at least one of a cyclic redundancy check (CRC) and a hashing function.

21. The apparatus according to claim 19, wherein the capture processor is arranged to identify the changed tiles when the respective current signatures differ from the respective reference signatures, and comprising a tile difference table comprising Boolean flags, wherein the capture processor is arranged to set Boolean flags in the tile difference table indicating the respective identified changed tiles.

22. The apparatus according to claim 19, wherein the capture processor is arranged to capture and output the pixel values of at least some of the changed tiles in a third image subsequent to the second image in the sequence.

23. The apparatus according to claim 19, and comprising a tile cache memory arranged to hold tiles, wherein the capture processor is arranged to store only changed tiles of the second image in the tile cache memory.

24. The apparatus according to claim 19, wherein each of the images is divided into N tiles, and wherein the capture processor is arranged to store no more than 0.02N of the tiles of the second image.

25. The apparatus according to claim 24, wherein the capture processor is arranged to store no more than 0.01N of the tiles of the second image.

26. The apparatus according to claim 19, wherein the capture processor is implemented in an integrated circuit (IC), which further comprises an on-chip memory, and wherein the capture processor is arranged to store the reference signatures and the changed tiles in the on-chip memory.

27. The apparatus according to claim 19, wherein the capture processor is arranged to store at least one of the reference signatures and the changed tiles in an external memory.

28. The apparatus according to claim 19, wherein the capture processor is arranged to define a prioritization over the changed tiles and to select and output one or more of the changed tiles responsively to the prioritization.

29. The apparatus according to claim 28, wherein the capture processor is arranged to acquire the second image in accordance with a scanning pattern, and to select the one or more of the changed tiles responsively to a current position in the scanning pattern.

30. The apparatus according to claim 28, wherein the capture processor is arranged to produce an interrupt responsively to identifying a changed tile, and to output the identified changed tile responsively to the interrupt.

31. The apparatus according to claim 19, wherein the sequence of images is produced at a remote computer, and wherein the controller is arranged to transmit at least some of the changed tiles over a communication link from the remote computer to a controlling computer.

32. The apparatus according to claim 19, wherein the tiles comprise first and second partially overlapping tiles such that at least one of the pixels is common to the first and second partially overlapping tiles.

33. A system for transferring a sequence of video frames that include pixels having respective pixel values, comprising:
a remote computer, comprising:
a graphic processor, which is arranged to produce the sequence of video frames; and
a capture processor, which is arranged to divide each of the video frames into tiles, each tile comprising a group of the pixels, to accept a definition of a tile signature that represents the pixel values of the pixels of a given tile using a single numerical value, such that a change in the signature is indicative of a change in at least one of the pixel values of the pixels of the given tile, to compute and store respective reference signatures of the tiles of a first video frame in the sequence based on the pixel values of the pixels in each of the tiles in the first video frame, to accept an input data sequence representing respective current pixel values of a second video frame, to compute respective current signatures of the tiles of a second video frame in the sequence based on the pixel values of the pixels in each of the tiles in the second video frame, to identify changed tiles in the second video frame with respect to the first video frame by comparing the respective current signatures to the respective reference signatures of the tiles, and to transmit at least some of the changed tiles over a communication link; and
a controlling computer, which is arranged to accept the changed tiles transmitted over the communication link and to reconstruct the sequence of video frames using the changed tiles.

34. The system according to claim 33, wherein the controlling computer is arranged to display the reconstructed video frames to a user.

35. The system according to claim 33, wherein the controlling computer is arranged to control the remote computer using the reconstructed video frames.

36. The system according to claim 33, wherein the remote computer is arranged to refrain from transmitting unchanged tiles to the controlling computer.

37. The system according to claim 33, wherein the remote computer is arranged to refrain from storing unchanged tiles.
